(19) United States
(12) Patent Application Publication
(10) Pub. No.: US 2013/0131845 A1
(43) Pub. Date: May 23, 2013

(54) SYSTEM FOR MANAGING EQUIPMENT OF AN OPERATIONAL BLOCK AND CORRESPNODING USE

(71) Applicant: Bertrand Guilleminot, Villermain (FR)

(72) Inventor: Bertrand Guilleminot, Villermain (FR)

(73) Assignee: MAQUET SAS, Ardon (FR)

(21) Appl. No.: 13/809,526

(22) PCT Filed: Jul. 19, 2011
(86) PCT No.: PCT/FR2011/051729

§ 371 Date: Jan. 10, 2013

(30) Foreign Application Priority Data
Jul. 20, 2010 (FR) 10 55908

(51) Int. Cl. G05B 11/01

(52) U.S. Cl. CPC G05B 11/01
USPC 700/83

(57) ABSTRACT

A system (6) for managing equipment in an operating theater (4) having at least two operating rooms (8), in which each operating room (8) has at least one piece of equipment (10), comprises at least one remote control (12), and for each remote control (12) association means (14) associating the or each remote control (12) exclusively with one of the operating rooms (8) so as to authorize at least one remote control (12) to control at least one piece of equipment (10) in the associated room (8) and so as to inhibit the at least one remote control (12) from controlling each piece of equipment (10) in each of the other operating rooms (8) with which the at least one remote control (12) is not associated; and modification means (16) adapted to modify the association means (14) in such a manner that the association means (14) associate the at least one remote control (12) exclusively with another one of the at least two operating rooms (8).

The present invention relates to a management system for managing equipment in an operating theater, the operating theater having at least two operating rooms, with each operating room having at least one piece of equipment, the management system having at least one remote control adapted to control at least one piece of equipment in each of the rooms.

The invention applies in particular to controlling equipment in an operating theater while minimizing the movements required of the medical team.

In the prior art, remote controls are known, each including a transmitter for controlling an appliance that includes a receiver. Those remote controls make use of infrared waves for communication between the transmitter and the receiver.

The use of infrared waves for communication by remote controls presents several drawbacks. Firstly, an infrared remote control becomes inoperative if the propagation path for the infrared waves becomes obstructed by an obstacle, such as a member of the medical team or some other equipment in the operating room. Secondly, infrared waves are not suitable for transmitting large volumes of data, such as images. Thirdly, with a low-power infrared wave transmitter, the user must point the transmitter of the remote control properly towards the receiver of the equipment in order to be able to control the appliance, which may be difficult or impossible.

With a high power infrared wave transmitter, the third problem does not arise. However, under such circumstances, the use of remote controls that employ a simple infrared wave communications protocol in a system for managing equipment in an operating theater having a plurality of operating rooms leads to safety risks. By way of example, one such risk is that a user controls equipment other than the equipment that was intended, in particular equipment in an operating room other than the room in which the user is working at a given instant.

In the prior art, it is also known to use control panels for remotely controlling equipment in an operating theater, which panels are permanently fastened, e.g. to a wall in an operating room, with the control panels making use of radio frequency (RF) waves. For control purposes, such a system thus requires a member of the medical team to move up to the control panel.

An object of the present invention is to provide a system for managing operating theater equipment that is ergonomic and that minimizes the movements required of the medical team, while not presenting at least one of the above-mentioned drawbacks.

To this end, the invention provides a system of the above-mentioned type for managing equipment in an operating theater and characterized in that for each remote control it comprises:
association means associating the or each remote control exclusively with one of the operating rooms so as to authorize at least one remote control to control at least one piece of equipment in the associated room and so as to inhibit the at least one remote control from controlling each piece of equipment in each of the other operating rooms with which the at least one remote control is not associated; and
modification means adapted to modify the association means in such a manner that the association means associate the at least one remote control exclusively with another one of the at least two operating rooms.

In other embodiments, the management system of the invention includes one or more of the following characteristics:
communications means for communication between the or each remote control and the or each piece of equipment in each operating room, the communications means being suitable for communicating command signals from the remote control to the or each piece of equipment;
the communications means comprise a first transmitter arranged in each remote control, and each operating room includes at least one corresponding first receiver, the first transmitter and the first receiver using a radiofrequency communications link for controlling the equipment of the associated room;
the communications means define a first class of commands for a piece of equipment and a second class of commands for said piece of equipment;
inhibition means adapted to inhibit the control of the equipment by the remote control when the equipment belongs to an operating room other than the room with which the remote control is associated, but only when the command belongs to the first command class, but not when the command belongs to the second command class;
authorization means that are adapted to authorize the remote control to control the equipment in the operating room with which the remote control is associated only when the remote control is located within a defined perimeter, e.g. within the associated room, and to prevent the remote control from controlling the equipment in the operating room with which it is associated when the remote control is located outside the defined perimeter;
the authorization means comprise at least one of the following:
   a locating device for locating the remote control, the locating device making use in particular of a triangulation principle;
   a second transmitter using a radiofrequency communications link having range that is shorter than the range of the first transmitter;
   a second transmitter using an infrared wave communications link requiring the remote control to be pointed at the equipment that is to be controlled or at the corresponding first receiver;
   a second transmitter using an ultrasound wave communications link; and
   the first transmitter and range adjustment means, the first transmitter being a transmitter of adjustable range and the range adjustment means adjusting the range in such a manner that it is shorter when the command belongs to the first class than when the command belongs to the second class;
the management system comprises an association station and connection means for connecting the remote control to the association station, the modification means being adapted to modify the association when the remote control is connected to the association station by the connection means;
the association station includes a man-machine interface adapted to allow a user to select one of the operating rooms with which the remote control is to be associated;
a confirmation station adapted to confirm the association between the remote control and the room and to inhibit the remote control from controlling the equipment of the associated room before the association has been confirmed;
the association station and/or the confirmation station is/are adapted to communicate with the or each remote control via a link of the “Bluetooth®” type, in particular of the “Bluetooth 2.0®” or later type, or of the “ZigBee” type; and
a supervisor device arranged in each operating room, each supervisor device being connected to at least one piece of equipment and preferably to at least two pieces of equipment in the operating room, the supervisor device including the corresponding first receiver and, where appropriate, association means storing information associating the identifier of the or each remote control associated with the operating room.

The invention also provides a use of a management system as specified above for managing the equipment of an operating theater, the operating theater having at least two operating rooms, each operating room having at least one piece of equipment, the use comprising the following steps:
using the association means to associate the or each remote control exclusively with one of the at least two operating rooms;
using the remote control means to control the equipment in the associated operating room and optionally to inhibit that remote control from controlling the equipment in each of the at least two rooms with which the remote control is not associated; and
modifying the association of the or each remote control with one of the operating rooms of the at least two rooms by using the modification means to associate the remote control with another one of the at least two operating rooms.

The invention can be better understood on reading the following description given purely by way of example and made with reference to the accompanying drawings, in which:

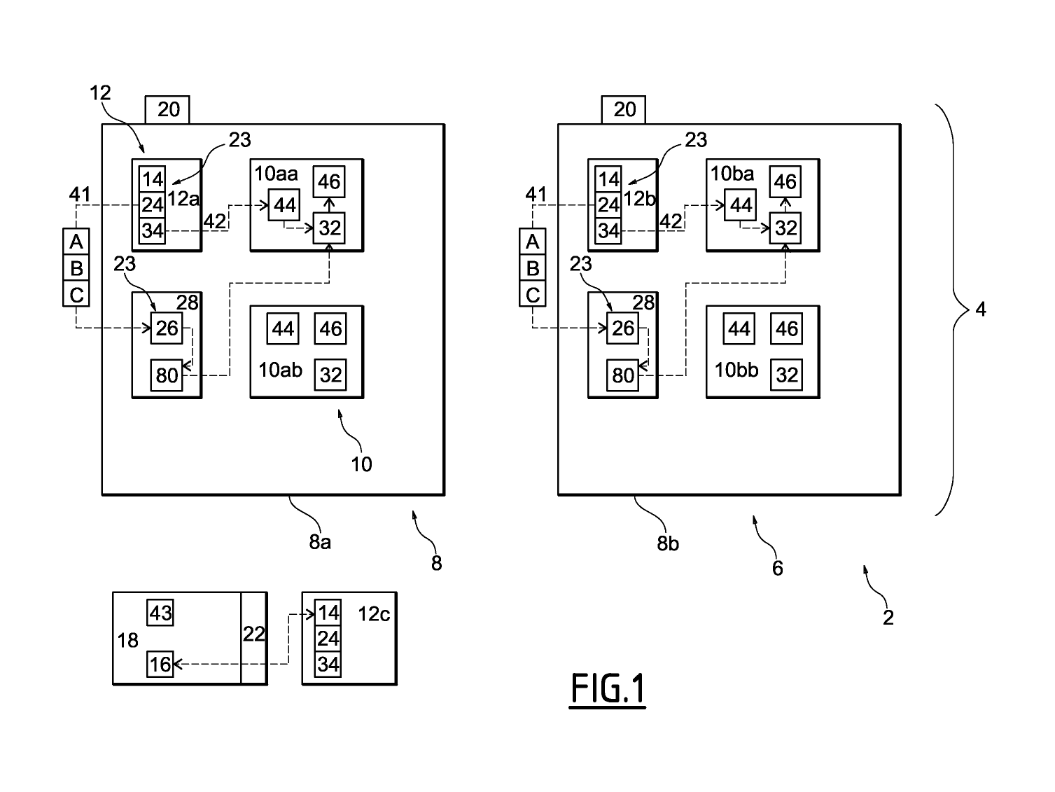

FIG. 1 is a diagrammatic view of a system of the invention for managing operating theater equipment, the system having three remote controls, two of which are authorized to control an associated piece of equipment;

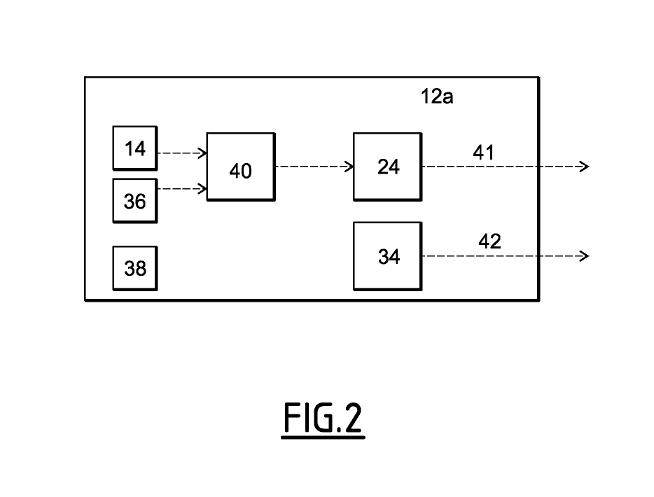

FIG. 2 is a detailed diagram of one of the remote controls of FIG. 1; and

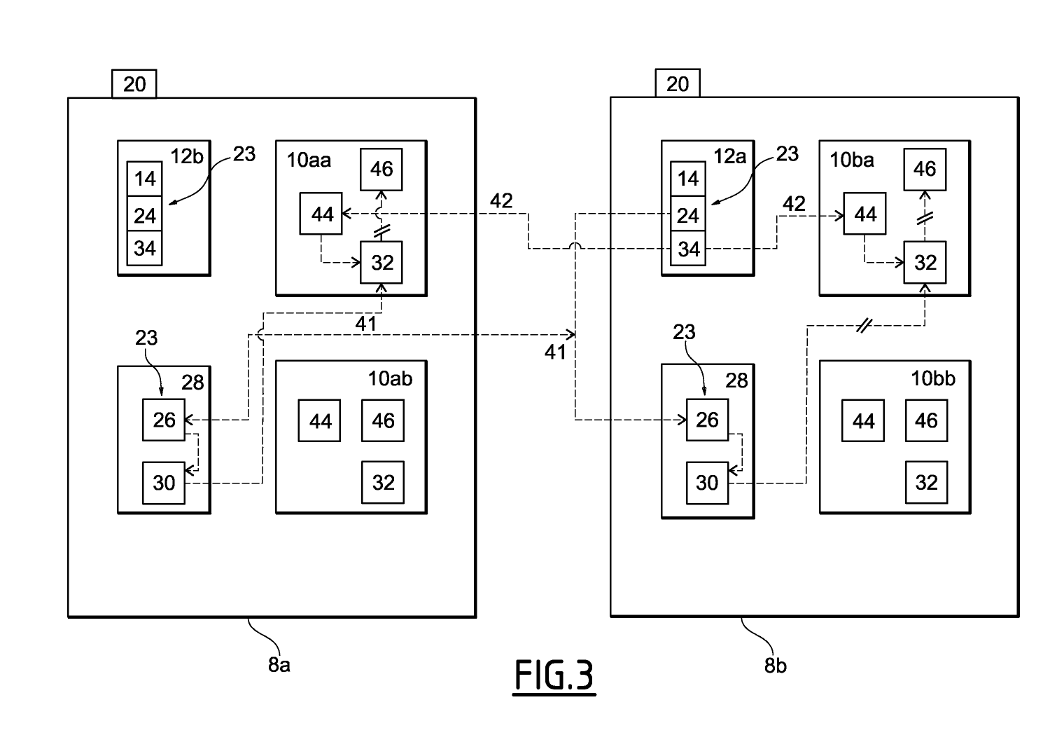

FIG. 3 is a diagrammatic view of the FIG. 1 system for managing operating theater equipment, with the two remote controls being inhibited from controlling the associated pieces of equipment.

FIG. 1 shows a management unit given overall reference 2, the management unit 2 comprising an operating theater 4 and a first equipment of a system 6 for managing equipment of the operating theater 4. By way of example, the operating theater 4 comprises two operating rooms 8, namely operating rooms 8a and 8b. Each operating room 8 has two pieces of equipment 10. The room 8a has pieces of equipment 10aa and 10ab. The room 8b has pieces of equipment 10ba and 10bb. Nevertheless, the operating theater 4 could have some other number of operating rooms 8, each of which could have any number of pieces of equipment 10. Each operating room 8 is characterized by a unique address.

The term “piece of equipment” 10 designates any electronic and/or mechatronic appliance suitable for performing a function on being commanded by a user, such as operating lighting, audiovisual equipment (monitor, camera), a motor-driven support arm, a computer-assisted surgical arm, an operating table (in particular for varying the height or the operating of the table), or blinds adapted to veil transparent walls of the operating room.

The management system 6 includes at least one remote control 12, with each remote control 12 having association means 14 and modification means 16. The management system 6 also has at least one association station 18, at least one confirmation station 20, connection means 22, communications means 23 in the form of a first transmitter 24 and a first receiver 26, at least one supervisor device 28 for each operating room 8, inhibit means 30, and authorization means 32.

In the example shown in FIG. 1, the management system 6 has three remote controls 12a, 12b, and 12c. By way of example, the remote control 12a is shown in detail in FIG. 2. Each remote control 12 has a first transmitter 24 of the communications means 23, a second transmitter 34, and association means 14. Each remote control 12 also has a command generator 36, a rechargeable battery 38, and a verification module 40 (FIG. 2). The first transmitter 24 is adapted to transmit a signal 41 representing a command. The command signal 41 contains the following information (FIG. 1):
A: an association between the remote control 12 and one of the operating rooms 8;
B: the piece of equipment 10 for which the command is intended; and
C: the command that is to be executed.
   The second transmitter 34 is adapted to transmit a location signal 42. The verification module 40 is adapted to verify whether it has been confirmed that the remote control 12 is associated with an operating room 8 by means of one of the confirmation stations 20. The command generator 36 is adapted to generate the command signal 41.

Each remote control 12 is adapted to control one or more pieces of equipment 10 in each of the operating rooms 8. Each remote control 12 is preferably adapted to control each of the pieces of equipment 10 in each of the operating rooms 8. Each remote control 12 is characterized by a unique identifier.

The association means 14 are adapted to store information representing one or more exclusive associations between the unique identifier of a remote control 12 and the unique address of one of the operating rooms 8. By means of this association information, the association means 14 are adapted to authorize a remote control 12 to control the equipment 10 in the associated operating room 8 and to inhibit the remote control 12 from controlling the equipment 10 in the other operating room 8 that is not associated therewith.

In a first variant of the first embodiment, the association means 14 comprise a central memory to which all of the elements of the management system 6 that require association information are connected. In a second variant of the first equipment, the association means 14 are incorporated in all of the elements of the management system 6 that require association information. These elements are the remote controls 12, the modification means 16, the association stations 18, the confirmation stations 20, the communications means 23, the supervisor devices 28, the inhibit means 30, and the authorization means 32.

The modification means 16 are adapted to modify the information representing the association(s) stored in the association means 14. By way of example, the modification means 16 comprise a processor and memory containing a program.

Each association station 18 is adapted to associate each remote control 12 in modifiable manner exclusively with one of the two operating rooms 8 and to modify such an association. The association stations 18 include respective man-machine interfaces 43 adapted to allow a user to select an operating room 8 with which it is desired to associate the remote control 12. For this purpose, the association means 18 are connected to the modification means 16 or they incorporate the modification means 16. By way of example, the association stations 18 are in the form of control desks. The association stations 18 are arranged outside the operating rooms 8. The association stations 18 are also adapted to update the remote controls 12 when the management system 6 is updated.

The management system 6 and/or the association stations 18 are adapted to modify the association of a remote control in response to the association selected by a user.

Each association station 18 also has charger means (not shown) for recharging the rechargeable batteries 38. By way of example, these charger means are induction charger means. The charger means comprise a first induction coil connected to the batteries 38 and a second coil for charging that is arranged in the association station 18. Thus, when the remote controls 12 are connected to one of the association stations 18 in order to modify their association, their batteries 38 are simultaneously recharged.

In a variant, the association stations 18 are not physical stations but are predetermined geographical zones within which the user associates each remote control 12 exclusively with one of the two operating rooms 8 without making physical contact between the remote controls 12 and the association station 18. Under such circumstances, the man-machine interface 43 is incorporated in each of the remote controls 12, and the charger means are separate from the association stations 18.

The confirmation stations 20 are adapted to confirm the association made with one of the association stations 18. A remote control 12 associated with an operating room 8 is authorized to control the equipment 10 in the associated operating room 8 only after the association has been confirmed by means of one of the confirmation stations 20. The confirmation stations 20 are arranged either together with the association stations 18, or at the entrances to each of the operating rooms 8, or between those locations.

The connection means 22 are adapted to establish a connection, at least a computer connection, between the remote controls 12 and the association station 18, and also between the remote controls 12 and the confirmation station 20. This connection connects the association station 18 and the confirmation station 20 with the association means 14 incorporated in the remote controls 12. The connection is adapted to transmitting signals representing the association “operating room 8—remote control 12”. The connection is preferably a connection of the “Bluetooth®” type, in particular of the “Bluetooth 2.0®” or later type. The connection means 22 are incorporated in the association station 18 and in the confirmation station 20.

The Bluetooth® standard complies with the IEEE 802.15.1 standard or is identical thereto.

In a variant, the connection may be a connection in compliance with the “ZigBee” standard, or satisfying the standard IEEE 802.15.4.

The communications means 23 are adapted to set up and provide communication, and in particular a transfer of command signals 41, between the remote control 12 and the equipment 10 of the associated operating room 8 by using an RF communications protocol. The communications means 23 are the first transmitters 24 and the first receivers 26. The first transmitters 24 are incorporated in each of the remote controls 12. The first receivers 26 are incorporated in each supervisor device 28. The communications means 23 are also adapted to define classes of commands. The communications means 23 are also adapted to identify the class to which a given command C belongs. By way of example, a distinction is made between a first class of command and a second class of command. The first class of command is made up of commands C that are said to be “critical”. Critical commands C are commands C that, on being executed, are potentially dangerous for the patient or for staff. The second class of command comprises all of the other commands C.

Each supervisor device 28 is adapted to receive the command signals 41 coming from the first transmitter 24 of each remote control 12. The supervisor device 28 includes the first receiver 26. The supervisor device 28 is connected to one or more pieces of equipment 10 in a given room 8 and it is adapted to forward the command signals 41 to the corresponding pieces of equipment 10.

In a variant, the supervisor device 28 is connected to all of the pieces of equipment 10 in an operating room 8 and is adapted to forward the command signals 41 to all of those pieces of equipment 10. The supervisor device 28 thus takes on the role of a “collective” receiver of command signals 41 for all of the pieces of equipment 10 connected to the supervisor device 28. Each operating room 8 has one or more supervisor devices 28.

When the command C belongs to the first class of commands, the inhibit means 30 are adapted to inhibit the control of a piece of equipment 10 by the remote control 12 when the equipment 10 belongs to an operating room 8 other than the operating room 8 with which the remote control 12 is associated. When the command C belongs to the second class of commands, the inhibit means 30 are not adapted to inhibit the equipment 10 being controlled by the remote control 12 even when the equipment 10 belongs to an operating room 8 other than the operating room 8 with which the remote control 12 is associated. The inhibit means 30 thus operate as a function of the command class. The inhibit means 30 are incorporated in the supervisor device 28. The inhibit means 30 are connected to first receiver 26.

The authorization means 32 are adapted to authorize the remote control 12 to control the piece(s) of equipment 10 in the associated operating room 8 when the remote control 12 is located within a predefined perimeter and when the command C belongs to the first class of commands. The authorization means 32 are also adapted to inhibit the remote control 12 controlling the piece(s) of equipment 10 in the associated operating room 8 when the remote control 12 is located outside the predefined perimeter and when the command C belongs to the first class of commands. The authorization means 32 thus operate as a function of the location of the remote control 12 relative to the predefined perimeter. For this purpose, the authorization means 32 are connected to the inhibit means 30.

The authorization means 32 are also adapted to locate a remote control 12 emitting a location signal 42 and to determine the position of the remote control 12 relative to the predefined perimeter. The predefined perimeter is substantially spherical in shape having a radius of 5 meters (m). Typically, the predefined perimeter includes all of the corresponding operating rooms 8. Nevertheless, it is entirely possible to define a perimeter that is smaller than the corresponding operating room 8. For this purpose, the authorization means 32 comprise at least one of the following:
The authorization means 32 comprise a device for locating the remote control 12. This locating device is adapted to determine a position for the remote control 12 by triangulation.
The authorization means 32 include a second receiver 44 adapted to receive the location signal 42 from the second transmitter 34 of the remote control 12, the second receivers and transmitters 44 and 34 using an RF communications link of range that is shorter than that of the first transmitter 24 and of the first receiver 26. The range of the link between the second transmitters and receivers 34 and 44 determines said perimeter.

In a variant, the second receivers and transmitters 44 and 34 make use of a communications link by means of infrared waves.

In another variant, the second receivers and transmitters 44 and 34 make use of a communications link by ultrasound waves.

The second receiver 44 of the association means 32 is incorporated in each piece of equipment 10.

Each piece of equipment 10 also has a converter 46 adapted to translate a command into a function that corresponds with the equipment 10.

Below there follows a description of how the management system 6 is used, which description is given with reference to FIGS. 1 and 3.

Before entering one of the two operating rooms 8 of the operating theater 4, the user selects a remote control 12, e.g. the remote control 12a. Using the connection means 22, the remote control 12a is connected to one of the association stations 18. The interface 43 presents the user with all of the operating rooms 8 with which it is possible to associate the remote control 12a. The user selects one of the rooms 8, e.g. the room 8a, and establishes an association between the unique address of the room 8a and the unique identifier of the remote control 12a. Thereafter, the modification means 16 modify this association information for the remote control 12a and the association information is stored in the association means 14. This association is valid until a new association is made.

At this step, the confirmation station 20 still inhibits the remote control 12a from controlling the pieces of equipment 10aa and 10ab in the room 8a. For safety reasons, the management system 6 requires the association between the room 8a and the remote control 12a to be confirmed before canceling that inhibition. Using the connection means 22, the user connects the remote control 12a to the confirmation station 20 and confirms the most recent association of the remote control 12a as stored in the association means 14. Consequently, the confirmation station 20 removes the inhibition.

In the associated room 8a, the user may for example desire to control the piece of equipment 10aa. The first transmitter 24 of the remote control 12a transmits a corresponding RF command signal 41. The command signal 41 is transmitted to the first receiver 26 of the supervisor device 28 of the room 8a. The communications means 23 identify the class of commands to which the command C represented by the command signal 41 belongs. The inhibit means 30 authorize the remote control 12a to control the piece of equipment 10aa when the command in the signal 41 belongs to the first class of commands and when the remote control 12a transmitting the signal 41 is associated with the operating room 8a in which the piece of equipment 10aa that is to be controlled is located (FIG. 1). Under such circumstances, this particular remote control 12a is also authorized to control any other piece of equipment 10ab that is present in the operating room 8a with which the remote control 12a is associated.

Suppose that the user happens to enter into the room 8b with which the remote control 12a is not associated. In the event that the command C belongs to the first command class, but the remote control 12a transmitting the signal 41 is not associated with the operating room 8b in which the equipment 10ba is located that the user seeks to control, the inhibit means 30 inhibit this remote control 12a from controlling the piece of equipment 10ab present in the operating room 8b in which the remote control 12a is located (FIG. 3). Under such circumstances, the remote control 12a is likewise inhibited from controlling any other piece of equipment 10bb present in the operating room 8b with which the remote control 12a is not associated.

In the event of the command C belonging to the second command class, the inhibit means 30 always allow the remote control 12a to control the piece of equipment 10aa, and any other piece of equipment 10ab, 10ba, 10bb.

The authorization means 32 locate the remote control 12a and determine whether the remote control 12a is inside or outside the predefined perimeter, in particular inside or outside the operating room 8a.

The remote control 12a is located on one of the following principles or by a combination of more than one of these principles:
The locating device determines the position of the remote control 12a relative to stationary reference points in the operating room 8a by triangulation. The authorization means 32 determine whether the position of the remote control 12a is inside or outside the predetermined perimeter.
The second transmitter 34 of the remote control 12a transmits a location RF signal 42 of range that is limited compared with the range of the command RF signal 41. If the distance between the second transmitter 34 of the remote control 12a and the second receiver 44 of the authorization means 32 of the piece of equipment 10aa is shorter than or equal to the limited range of the location RF signal 42, the location RF signal 42 passes from the second transmitter 34 to the second receiver 44. The remote control 12a is thus considered as being within the predetermined perimeter. In contrast, if the distance between the second transmitter 34 of the remote control 12a and the second receiver 44 of the authorization means 32 of the piece of equipment 10aa is greater than the limited range of the location RF signal 42, then the location RF signal 42 does not pass from the second transmitter 34 to the second receiver 44. The remote control 12a is thus considered as not being within the predetermined perimeter.
The second transmitter 34 of the remote control 12a transmits a location signal 42 at an infrared wavelength. The remote control 12a is considered as being within the predetermined perimeter if the infrared waves pass from the second transmitter 34 and reach the second receiver 44 of the authorization means 32 of the piece of equipment 10aa. The infrared waves pass from the second transmitter 34 to the second receiver 44 only if their path is not obstructed by an obstacle.
The second transmitter 34 of the remote control 12a transmits an ultrasound location signal 42 of limited range so as to cover a predetermined perimeter. The remote control is considered as being within the predetermined perimeter if the ultrasound waves pass from the second transmitter to the second receiver of the authorization means with at least a determined power level.

When the command C belongs to the first command class, the inhibit means 30 authorize the remote control 12a to control the piece of equipment 10aa, and when the remote control 12a is within the predetermined perimeter, in particular within the room 8a, the authorization means 32 also authorize the remote control 12a to control at least the piece of equipment 10aa (FIG. 1). Under such circumstances, and preferably, the authorization means 32 authorize the remote control 12a to control all of the pieces of equipment 10aa, 10ab present in the room 8a.

When the command C belongs to the first command class, the inhibit means 30 authorize the remote control 12a to control the equipment 10, and when the remote control 12a lies outside the predetermined perimeter, in particular in the room 8b, the remote control 12a is inhibited from controlling the piece of equipment 10aa by the authorization means 32 (FIG. 3).

When the command belongs to the second command class, the authorization means 32 authorize the remote control 12a to control the piece of equipment 10aa independently of the position of the remote control 12a relative to the predetermined perimeter.

In other words, when the command C belongs to the first command class, the remote control 12 must: a) be associated with the room 8 in which the equipment 10 to be controlled is located; and b) be located within the predetermined perimeter in order for the remote control 12 to be authorized to control the equipment 10 (FIG. 1). If one or both of the conditions a) and b) is/are not satisfied, the remote control 12 is not authorized to control the equipment 10 (FIG. 3).

When the command belongs to the second command class, the remote control 12 is authorized to control the equipment 10 independently of the conditions a) and b).

In the example shown in FIG. 1, the management system 6 has three remote controls 12a, 12b, and 12c, and two operating rooms 8a and 8b, each room 8 being associated with only one remote control 12.

Nevertheless, the management system 6 of the invention is adapted to associate a given room 8 with any number of remote controls 12. This makes it possible for several users to control the equipment 10 in a given room 8. In contrast, any one remote control 12 is associated either with no room 8, or else with only one room 8.

It should be observed that each remote control 12 is adapted to control each of the pieces of equipment 10 in the operating theater 4. Nevertheless, for commands C that belong to the first command class, above conditions a) and b) must be satisfied in order for the remote controls 12 to be authorized to control any of the pieces of equipment 10. Consequently, while the remote control 12a is associated with the room 8a, the remote control 12a is never suitable for controlling all of the equipment 10 in the operating theater 4, nor two pieces of equipment 10ab, 10bb belonging to two different operating theaters 8a and 8b.

In a second embodiment, which differs from the first embodiment solely by what follows, the management system 6 does not have a supervisor device 28 or has such a device only in some of the operating rooms 8. For rooms 8 that do not have a supervisor device 28, the first receivers 26 for receiving the command signals 41 and the inhibit means 30 are incorporated in each of the pieces of equipment 10 in these rooms 8. Under such circumstances, each piece of equipment 10 has a first receiver 26 for receiving the command signals 41 and also the second receiver 44 for receiving the signals 42 suitable for locating the remote controls 12.

In a third embodiment, which differs from the first embodiment solely by what follows, the supervisor device 28 further includes the second receiver 44 and the authorization means 32, while each piece of equipment 10 includes neither a second receiver 44 nor authorization means 32. In this embodiment, the supervisor device 28 is adapted to receiver the signals 41 representing a command and also the location signals 42.

In a variant of the third embodiment, the second receiver 44 receiving the location signals 42 is a ring made up of radiofrequency identification (RFID) tags, the ring occupying the periphery of the operating room 8, e.g. close to the ceiling of the operating room 8.

The management system 6 of the invention is adapted to ensure that communication between the remote controls 12 and the equipment 10 in an operating theater 4 is safe. In particular, the management system 6 avoids a first user fortuitously controlling equipment 10 that is being used by a second user in an operating room 8 other than the room in which the first user is located. Nevertheless, the management system 6 of the invention does not restrict comfort in use: there is no physical link between the user and the pieces of equipment 10, the management system 6 avoids the medical team having to move, and communication between the remote controls 12 and the pieces of equipment 10 is not impeded by obstacles.

In a variant that is not shown, the management system includes the first transmitter 24 which is a transmitter of adjustable range and it also includes means for adjusting its range. These range-adjustment means adjust the range of the transmitter 24 so that it is shorter when the command belongs to the first class than when the command belongs to the second class.

What is claimed is:

1. A management system (6) for managing equipment in an operating theater (4), the operating theater (4) having at least two operating rooms (8), with each operating room (8) having at least one piece of equipment (10), the management system (6) having at least one remote control (12) adapted to control at least one piece of equipment (10) in each of the rooms (8), the management system (6) having for each remote control (12):
association means (14) associating the or each remote control (12) exclusively with one of the operating rooms (8) so as to authorize at least one remote control (12) to control at least one piece of equipment (10) in the associated room (8) and so as to inhibit the at least one remote control (12) from controlling each piece of equipment (10) in each of the other operating rooms (8) with which the at least one remote control (12) is not associated; and
modification means (16) adapted to modify the association means (14) in such a manner that the association means (14) associate the at least one remote control (12) exclusively with another one of the at least two operating rooms (8),
characterized in that the management system (6) comprises an association station (18) and connection means (22) for connecting the remote control (12) to the association station (18), the modification means (16) being adapted to modify the association when the remote control (12) is connected to the association station (18) by the connection means (22), the association station (18) includes a man-machine interface (43) adapted to allow a user to select one of the operating rooms (8) with which the remote control (12) is to be associated.

2. A management system (6) for managing equipment in an operating theater (4) according to claim 1, including communications means (23) for communication between the or each remote control (12) and the or each piece of equipment (10) in each operating room (8), the communications means being suitable for communicating command signals (41) from the remote control (12) to the or each piece of equipment (10), wherein the communications means (23) define a first class of commands for a piece of equipment (10) consisting of critical commands and a second class of commands for said piece of equipment (10) consisting of other commands than critical commands, and in that there is provided inhibition means (30) adapted to inhibit the control of the equipment (10) by the remote control (12) when the equipment (10) belongs to an operating room (8) other than the room (8) with which the remote control (12) is associated, but only when the command belongs to the first command class, but not when the command belongs to the second command class.

3. A management system (6) according to claim 2, wherein the communications means (23) comprise a first transmitter (24) arranged in each remote control (12), and wherein each operating room (8) includes at least one corresponding first receiver (26), the first transmitter (24) and the first receiver (26) using a radiofrequency communications link for controlling the equipment (10) of the associated room (8).

4. A management system (6) according to claim 3, including authorization means (32) that are adapted to authorize the remote control (12) to control the equipment (10) in the operating room (8) with which the remote control (12) is associated only when the remote control (12) is located within a defined perimeter, e.g. within the associated room (8), and to prevent the remote control (12) from controlling the equipment (10) in the operating room (8) with which it is associated when the remote control (12) is located outside the defined perimeter.

5. A management system (6) according to claim 4, wherein the authorization means (32) comprise at least one of the following:
a locating device for locating the remote control (12), the locating device making use in particular of a triangulation principle;
a second transmitter (34) using a radiofrequency communications link having range that is shorter than the range of the first transmitter (24);
a second transmitter (34) using an infrared wave communications link requiring the remote control (12) to be pointed at the equipment (10) that is to be controlled or at the corresponding first receiver (26);
a second transmitter (34) using an ultrasound wave communications link; and
the first transmitter (24) and range adjustment means, the first transmitter (24) being a transmitter of adjustable range and the range adjustment means adjusting the range in such a manner that it is shorter when the command belongs to the first class than when the command belongs to the second class.

6. A management system (6) according to claim 5, including a confirmation station (20) adapted to confirm the association between the remote control (12) and the room (8) and to inhibit the remote control (12) from controlling the equipment (10) of the associated room (8) before the association has been confirmed.

7. A management system (6) according to claim 6, wherein, depending on circumstances, the association station (18) and/or the confirmation station (20) is/are adapted to communicate with the or each remote control (12) via a link of the “Bluetooth” type, in particular of the “Bluetooth 2.0” or later type, or of the “ZigBee” type.

8. A management system (6) according to claim 3, including a supervisor device (28) arranged in each operating room (8), each supervisor device (28) being connected to at least one piece of equipment (10) and preferably to at least two pieces of equipment (10) in the operating room (8), the supervisor device (28) including the corresponding first receiver (26) and, where appropriate, association means (14) storing information associating the identifier of the or each remote control (12) associated with the operating room (8).

9. The use of a management system (6) according to claim 1 for managing the equipment (10) of an operating theater (4), the operating theater (4) having at least two operating rooms (8), each operating room (8) having at least one piece of equipment (10), the use comprising the following steps:
using the association means (14) to associate the or each remote control (12) exclusively with one of the at least two operating rooms (8);
using the remote control means (12) to control the equipment (10) in the associated operating room (8) and optionally to inhibit that remote control (12) from controlling the equipment (10) in each of the at least two rooms (8) with which the remote control (12) is not associated; and
modifying the association of the or each remote control (12) with one of the operating rooms (8) of the at least two rooms (8) by using the modification means (16) to associate the remote control (12) with another one of the at least two operating rooms (8).

10. A management system (6) according to claim 1, including authorization means (32) that are adapted to authorize the remote control (12) to control the equipment (10) in the operating room (8) with which the remote control (12) is associated only when the remote control (12) is located within a defined perimeter, e.g. within the associated room (8), and to prevent the remote control (12) from controlling the equipment (10) in the operating room (8) with which it is associated when the remote control (12) is located outside the defined perimeter.

11. A management system (6) according to claim 10, wherein the authorization means (32) comprise at least one of the following:
a locating device for locating the remote control (12), the locating device making use in particular of a triangulation principle;
a second transmitter (34) using a radiofrequency communications link having range that is shorter than the range of the first transmitter (24);
a second transmitter (34) using an infrared wave communications link requiring the remote control (12) to be pointed at the equipment (10) that is to be controlled or at the corresponding first receiver (26); and
a second transmitter (34) using an ultrasound wave communications link.

12. A management system (6) according to claim 1, including a confirmation station (20) adapted to confirm the association between the remote control (12) and the room (8) and to inhibit the remote control (12) from controlling the equipment (10) of the associated room (8) before the association has been confirmed.

13. A management system (6) according to claim 12, wherein, depending on circumstances, the association station (18) and/or the confirmation station (20) is/are adapted to communicate with the or each remote control (12) via a link of the “Bluetooth” type, in particular of the “Bluetooth 2.0” or later type, or of the “ZigBee” type.
